(19) United States
(12) Patent Application Publication
(10) Pub. No.: US 2008/0103890 A1
(43) Pub. Date: May 1, 2008

(54) Apparatus and method for consumer product promotion using payment device

(75) Inventors: Mark Lulic, Mohegan Lake, NY (US); John Wankmueller, Great Neck, NY (US)

Correspondence Address: Ryan, Mason & Lewis, LLP, Suite 205, 1300 Post Road, Fairfield, CT, 06824, US

(73) Assignee: MasterCard International Incorporated, Purchase, NY (US)

(21) Appl. No.: 11/589,384

(22) Filed: Oct. 30, 2006

(51) Int. Cl. G06Q 30/00

(52) U.S. Cl. 705/14

(57) ABSTRACT

A consumer product promotional assembly includes a consumer product, and a prize associated with the consumer product, the prize being spendable in a payment card infrastructure. The prize may employ, for example, radio frequency (RF) contactless technology or a bar coded or printed account number. In some embodiments, the prize is flexible and can conform to non-planar surfaces of the product.

### FIELD OF THE INVENTION

The present invention relates generally to the electronic and computer arts, and, more particularly, to apparatus and methods for electronic payments.

### BACKGROUND OF THE INVENTION

New techniques are continuously sought to promote products. One previous promotion involved a major brand of soda cans. The manufacturer incorporated standard MasterCard® (MASTERCARD is a registered trademark of MasterCard International Incorporated of Purchase, New York, USA) plastic ID-1 pre-paid ISO (International Organization for Standardization) debit cards inside some cases of 24 cans of soda. The winning card was attached to an unseen corner of the package. The winner had to go to an automated teller machine (ATM) to find out what the winning amount was, and to obtain the winnings in cash—the card was not spendable in a payment card infrastructure.

WIPO Publication WO2004104760 discloses methods and apparatus for implementing loyalty programs using portable electronic data storage devices. Customer loyalty programs using portable data storage devices, e.g., smart cards, are described. Merchant terminals capable of reading and writing information to user smart cards are used to award points to customers based on a set of loyalty program information stored in the merchant terminal, at least some information read from the smart card, and information such as the purchase amount. Different terminals within a store maybe loaded with different loyalty program information allowing the program to be specific to a store department or location. Updating of loyalty program information from a server facilitates implementation of rapid changes in plans allowing plans to be modified or an hourly basis if desired as part of a particular promotion in a department. Bonus loyalty information is stored in the user device, eliminating any need to access a centralized location which stores point information to award and/or redeem loyalty awards.

U.S. Pat. No. 6,222,914 discloses a system and method for administration of an incentive award system having a delayed award payment using a credit instrument. Award points are earned in response to certain actions by the Participants and then credited to the Participant's credit card, but only after a predetermined time delay. Furthermore, the Participant must still be a customer in good standing with the credit card Sponsor at the end of this predetermined delay period in order to receive the awarded points. As used in the '914 reference, the term “credit card” is intended to encompass traditional credit cards, debit cards, smart cards, etc. which are commonly accepted as payment for purchases in place of cash or bank checks. The system therefore creates an incentive for the Participant to purchase the Sponsor's goods and/or services in order to earn award points, and further creates an incentive for the Participant to remain a loyal customer of the Sponsor in order to receive and redeem these award points at some point in the future. Each award point therefore serves a double function as a reward for using the Sponsor's products and/or services and also as an incentive for customer loyalty to the Sponsor.

U.S. Pat. No. 7,097,094 discloses a method of enabling anonymous electronic redemption of a token printed as part of a product label, the product label including machine-readable coded data, the method including the steps, performed in a computer system, of: receiving interaction data representing interaction of a sensing device with the coded data, the interaction data enabling electronic capture of: token data of the token; and a product identifier associated with the product label; assigning an alias ID to the token data; and transmitting the token data, the product identifier and the alias ID to a token administrator configured to redeem the token electronically.

In general, prior art approaches require redemption of points, or other redemption processes, and cannot be spent immediately. It would be desirable to overcome the deficiencies of prior art techniques.

### SUMMARY OF THE INVENTION

Principles of the present invention provide techniques for consumer product promotion using payment devices.

An exemplary embodiment of a consumer product promotional assembly, according to one aspect of the invention, includes a consumer product, and a prize associated with the consumer product, the prize being spendable in a payment card infrastructure. As used herein, “spendable in a payment card infrastructure” means that goods and/or services can be directly obtained by presenting the prize to a terminal of a payment card infrastructure, without the need for point redemption, obtaining cash, and the like. In one or more embodiments intended for use in one or more jurisdictions, an activation step may be needed to comply with financial security regulations, such as the United States “PATRIOT” Act. One or more embodiments of the invention may employ a flexible, even paper-based, card or device. Unlike traditional stiff plastic payment cards, one or more embodiments of the invention may include a prize which can be wrapped and/or are bendable, and can conform to the shape of the object to which they are attached.

The prize may take many different forms—it need not necessarily have traditional payment card dimensions, such as length or width. Further, one or more embodiments may employ radio frequency (RF) contactless technology, employing, for example, a proximity chip (in one or more embodiments, MASTERCARD PAYPASS® smart cards containing proximity payment devices known as transponders can be employed—MASTERCARD PAYPASS® is a registered trademark of MasterCard International Incorporated of Purchase, New York, USA). One or more embodiments will not have a magnetic stripe, and will be usable only in those parts of the payment card infrastructure where PAYPASS® devices or similar devices are accepted. Yet further, one or more embodiments may employ a prize in the form of a dual interface card—one of the interfaces can be proximity technology, while another might be, for example, a bar coded or printed account number (bar coded PAN numbers, which can be read by barcode readers to get the account data from the card or device, can be used by themselves in one or more embodiments).

In another aspect, an exemplary embodiment of an inventive combination includes a consumer product promotional assembly of the kind described, with a prize of a first kind, and a second consumer product, the second consumer product not having a prize of the first kind associated therewith, the second consumer product and the first consumer product being cooperatively cloaked such that an observer cannot readily discern that the second consumer product does not have the prize of the first kind associated therewith.

An exemplary embodiment of a method of facilitating a consumer product promotion (which can be, at least in part, computer-implemented), according to yet another aspect of the invention, includes the steps of receiving a request for setup of a routable payment account number for a prize associated with a consumer product (the prize being a payment device spendable in a payment card infrastructure); facilitating setup of the routable payment account number; and facilitating spending of value associated with the routable payment account number by a winner of the prize.

Techniques of the invention can be implemented, for example, via a computer-readable medium storing program code that executes inventive method steps, and in an apparatus including a memory and at least one processor coupled to the memory and operative to implement inventive method steps.

One or more techniques of the present invention can provide one or more of the following substantial beneficial technical effects. These can include, for example, the ability to have a prize in a mechanically flexible form that can conform to the contours of a consumer product, and that need not be constrained to a standard credit card form factor, so that it can be employed with many different types of consumer products. These thin flexible cards or devices can be made for less cost than traditional poly vinyl chloride (PVC)-based credit or debit cards. In some instances, the silicon chips do not require a protective coating (often referred to as a module) surrounding the silicon chip—which reduces production cost.

These and other features and advantages of the invention will become apparent from the following detailed description of illustrative embodiments thereof, which is to be read in connection with the accompanying drawings.

### BRIEF DESCRIPTION OF THE DRAWINGS

FIG. 1 shows an example of a payment infrastructure that an inventive prize can interact with;

FIG. 2 shows an exemplary embodiment of a consumer product promotional assembly according to an aspect of the invention;

FIG. 3 shows one specific implementation of the assembly of FIG. 2;

FIG. 4 shows another specific implementation of the assembly of FIG. 2;

FIG. 5 shows spending of value of prizes in FIGS. 3 and 4;

FIG. 6 shows a prize that can employ bar-coded or printed numerical account information;

FIG. 7 shows another exemplary embodiment of a consumer product promotional assembly according to an aspect of the invention;

FIG. 8 shows one possible variation on the embodiment of FIG. 7;

FIG. 9 shows an exemplary embodiment of an inventive combination;

FIG. 10 shows an exemplary consumer product with a “dummy” prize;

FIG. 11 shows a flow chart of exemplary method steps for facilitating a consumer product promotion; and

FIG. 12 is a block diagram of an exemplary computer system useful in one or more embodiments of the present invention.

### DETAILED DESCRIPTION OF PREFERRED EMBODIMENTS

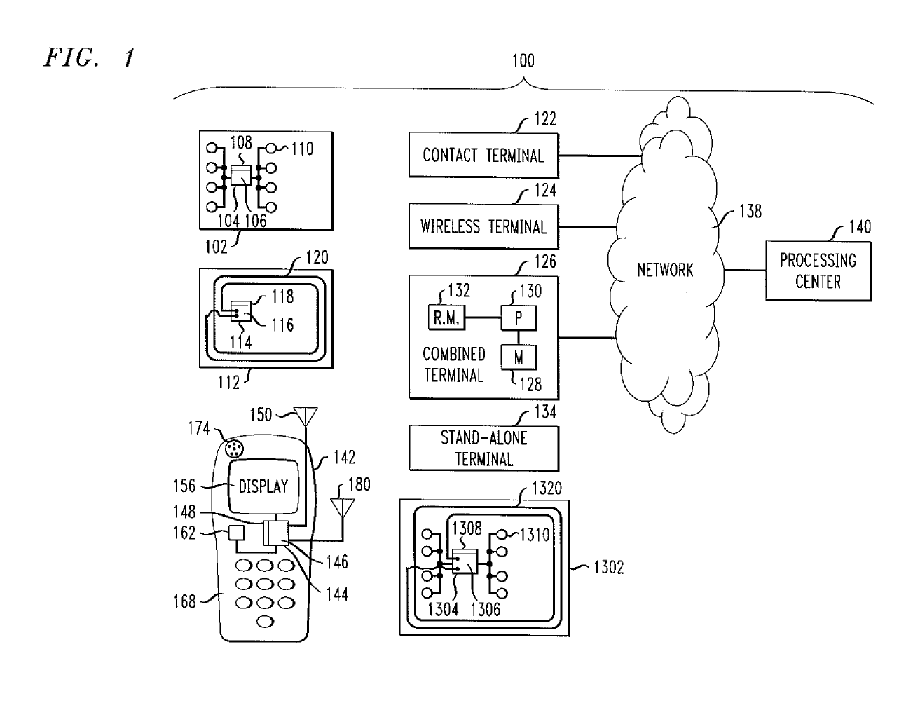

Attention should now be given to FIG. 1, which depicts an exemplary embodiment of a payment card infrastructure 100, together with various possible components thereof. System 100 can implement inventive techniques, and can include one or more different types of spendable prizes. One type of payment device can be a contact device such as card 102. Card 102 can include an integrated circuit (IC) chip 104 having a processor portion 106 and a memory portion 108. A plurality of electrical contacts 110 can be provided for communication purposes. Infrastructure 100 can also work with a contactless device such as card 112. Card 112 can include an IC chip 114 having a processor portion 116 and a memory portion 118. An antenna 120 can be provided for contactless communication, such as, for example, using radio frequency (RF) electromagnetic waves. An oscillator or oscillators, and/or additional appropriate circuitry for one or more of modulation, demodulation, downconversion, and the like can be provided. Note that cards 102, 112 are exemplary of a variety of devices that can be employed with techniques of the present invention. In one or more versions of the infrastructure, a dual-interface device 1302 is employed. Device 1302 is shown larger than devices 102, 112 for illustrative convenience but can have a similar form factor. Device 1302 includes an IC chip 1304 having a processor portion 1306 and a memory portion 1308. A plurality of electrical contacts 1310, similar to contacts 110, can be provided, as well as an antenna 1320 similar to antenna 120, together with an oscillator or oscillators, and/or additional appropriate circuitry for one or more of modulation, demodulation, downconversion, and the like, as described with regard to device 112. Appropriate firmware to manage the two available interfaces can be provided, with operation otherwise being similar to devices 102, 112. Other types of dual-interface devices may be employed; for example, a contactless interface with a scannable bar code, to be discussed further below. The description of devices, elements, or components 102, 104, 106, 108, 110, 112, 114, 116, 118, 120 throughout this document are equally applicable to the corresponding items 1302, 1304, 1306, 1308, 1310, 1320. Memories 108, 118, 148 (discussed below) and 1308 may further be divided into non-volatile and volatile memory.

The ICs 104, 114 can contain processing units 106, 116 and memory units 108, 118. Preferably, the ICs 104, 114 can also include one or more of control logic, a timer, and input/output ports. Such elements are well known in the IC art and are not separately illustrated. One or both of the ICs 104, 114 can also include a co-processor, again, well-known and not separately illustrated. The control logic can provide, in conjunction with processing units 106, 116, the control necessary to handle communications between memory unit 108, 118 and the input/output ports. The timer can provide a timing reference signal from processing units 106, 116 and the control logic. The co-processor could provide the ability to perform complex computations in real time, such as those required by cryptographic algorithms.

The memory portions or units 108, 118 may include different types of memory, such as volatile and non-volatile memory and read-only and programmable memory. The memory units can store transaction card data such as, e.g., a user's primary account number (“PAN”). The memory portions or units 108, 118 can store the operating system of the cards 102, 112. The operating system loads and executes applications and provides file management or other basic card services to the applications. In some embodiments, one or more applications may “sit” directly on hardware, e.g., may be outside the domain of the operating system. One operating system that can be used to implement the present invention is the MULTOS® operating system licensed by StepNexus Inc. Alternatively, JAVA CARD™-based operating systems, based on JAVA CARD™ technology (licensed by Sun Microsystems, Inc., 4150 Network Circle, Santa Clara, Calif. 95054 USA), or proprietary operating systems available from a number of vendors, could be employed. Preferably, the operating system is stored in read-only memory (“ROM”) within memory portion 108, 118. In an alternate embodiment, flash memory or other non-volatile and/or volatile types of memory may also be used in the memory units 108, 118.

In addition to the basic services provided by the operating system, memory portions 108, 118 may also include one or more applications as described herein. At present, one preferred standard to which such applications may conform is the EMV payment standard set forth by EMVCo, LLC (http://www.emvco.com). It will be appreciated that, strictly speaking, the EMV standard defines the behavior of a terminal; however, the card can be configured to conform to such EMV-compliant terminal behavior and in such a sense is itself EMV-compliant. It will also be appreciated that applications in accordance with the present invention can be configured in a variety of different ways.

As noted, cards 102, 112 are examples of a variety of payment devices that can be employed with the infrastructure. The primary function of the payment devices may not be payment, for example, they may be cellular phone handsets, or access cards for a public transportation system. Such devices could include cards having a conventional form factor, smaller or larger cards, cards of different shape, key fobs, personal digital assistants (PDAs), appropriately configured cell phone handsets, or indeed any device with the processing and memory capabilities to implement techniques of the present invention. The cards, or other payment devices, can include memories 108, 118 and processors 106, 116 coupled to the memories. Optionally, body portions (e.g., laminated plastic layers of a payment card, case or cabinet of a PDA, chip packaging, and the like) are associated with memories 108, 118 and processors 106, 116. The memories 108, 118 can contain applications as described herein. The processors 106, 116 can be operative to execute one or more method steps to be described herein. The applications can be, for example, application identifiers (AIDs) linked to software code in the form of firmware plus data in a card memory such as an electrically erasable programmable read-only memory (EEPROM).

A number of different types of terminals can be employed with infrastructure 100. Such terminals can include a contact terminal 122 configured to interface with contact-type device 102, a wireless terminal 124 configured to interface with wireless device 112, or a combined terminal 126. Note that “contactless” and “wireless” are used in an interchangeable fashion herein and that the skilled artisan is familiar with the meaning of such terminology. Combined terminal 126 is designed to interface with either type of device 102, 112, and may also interface with conventional magnetic stripe cards or devices, or with cards or devices having account information encoded thereon in bar code form (other terminals might work with just magnetic stripe or just bar code devices). Terminals may be contact terminals with plug-in contactless readers. Combined terminal 126 can include a memory 128, a processor portion 130, and a reader module 132. Note that the principles of construction of terminal 126 are applicable to other types of terminals and are described in detail for illustrative purposes. Reader module 132 can be configured for contact communication with card or device 102, or contactless communication with card or device 112, or both (different types of readers can be provided to interact with different types of cards e.g., contacted or contactless). Module 132 could also have a magnetic stripe reader, and/or a bar code scanner. Terminals 122, 124, 126 can be connected to a processing center 140 via a computer network 138. Network 138 could include, for example, the Internet, or a proprietary network. Processing center 140 can include, for example, a host computer of an issuer of a payment device. One or more distinct networks can be employed.

Stand-alone terminal 134 is representative of a terminal that is not connected to a computer network (either not connected at a particular time, or not connected at all, by design), and is otherwise generally similar to the other terminals described.

An appropriately configured cellular telephone handset 142 can also be employed in infrastructure 100. Handset 142 is depicted in semi-schematic form in FIG. 1, and can include one or more IC chips such as chip 144 including a processing unit 146 and a memory unit 148. Wireless communication with a terminal can be provided via antenna 150 or with a second antenna 180 similar to above-described antenna 120 (i.e., the handset could have a second antenna for the payment application). Note that antenna 180 is depicted schematically, but could be, e.g., a coil antenna as used in a typical “smart” card. Handsets 142 can each be equipped with a suitable display 156. Further, an appropriate power supply 162 can also be provided. Such power supplies can include, for example, a battery and appropriate circuitry. The display and power supply can be interconnected with the processor portion. Different types of portable payment devices can combine or “mix and match” one or more features depicted on the exemplary devices in FIG. 1.

It will be appreciated that the terminals 122, 124, 126, 134 are examples of terminal apparatuses for interacting with portable payment devices, including prizes in accordance with one or more exemplary embodiments of the present invention. The processor 130 can be operable to communicate with portable payment devices of a user via the communications module 132. The terminal apparatuses can function via hardware techniques in processor 130, or by program instructions stored in memory 128. Such logic could optionally be provided from a central location such as processing center 140 over network 138.

The above-described devices 102, 112 could be, for example, ISO 7816-compliant contact cards or devices or NFC (Near Field Communications) or ISO 14443-compliant proximity cards or devices. In operation, card 112 can be touched or tapped on the terminal 124 or 128, which then contactlessly transmits the electronic data to the proximity IC chip in the card 112 or other wireless device.

By way of review, FIG. 1 shows a typical payment card infrastructure in which a prize of one or more embodiments of the invention may be spendable.

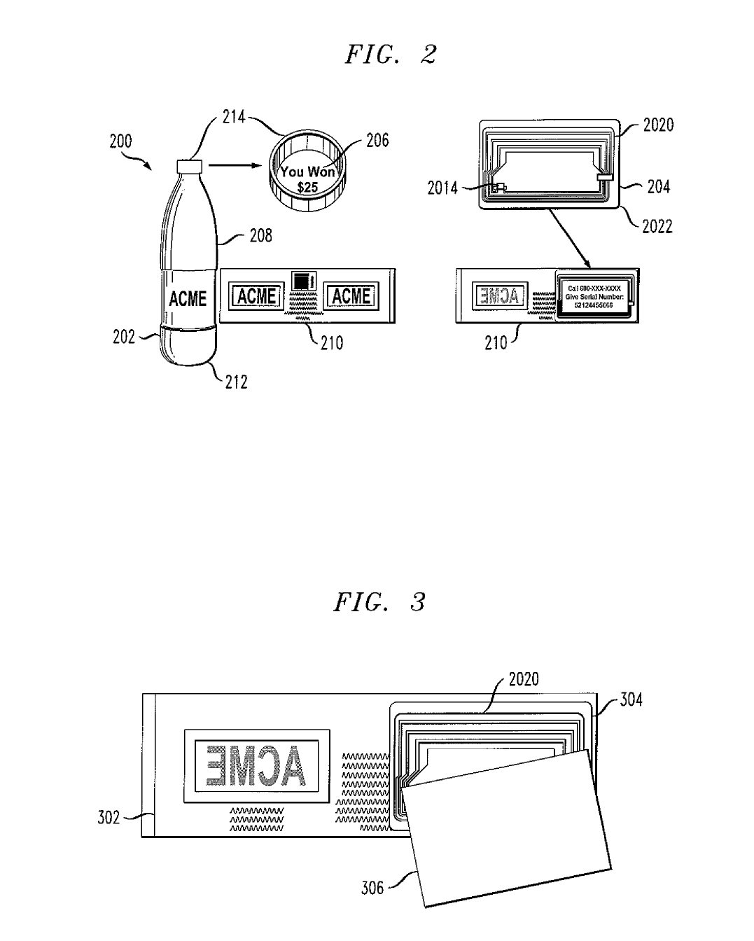

Giving attention now to FIG. 2, an exemplary embodiment of a consumer product promotional assembly 200 includes a consumer product 202 and a prize 204 associated with the consumer product 200. The prize 204 is spendable in a payment card infrastructure 100. As used herein, “spendable in a payment card infrastructure” means that goods and/or services can be directly obtained by presenting the prize to a terminal of a payment card infrastructure, without the need for point redemption, obtaining cash, and the like. In one or more embodiments intended for use in one or more jurisdictions, an activation step may be needed to comply with financial security regulations, such as the United States “PATRIOT” Act. As used herein, a prize is “associated” with a consumer product when it is in, on, or part of the product and/or the product's packaging.

Still with attention to FIG. 2, the assembly may further include an indication 206 of presence of the prize 204. The indication 206 is associated with the product 202 and/or the prize 204. In many cases, it will be undesirable that the assembly be discernable as a “winner” before purchase; however, in some cases, such as, for example, a rebate in a private or closed loop environment, the indication of the prize may be desirably discernable before purchase. Note that “prize” as used herein is intended to encompass both cases. Thus, in one or more embodiments, the indication 206 of the presence is hidden from a purchaser in a pre-purchase configuration and visible to the purchaser in a post-purchase configuration. In the specific embodiment depicted in FIG. 2, the indication 206 of the presence further comprises an indication of a value of the prize (in the specific instance, $25).

In one or more embodiments, the prize 204 comprises a radio-frequency (RF) contactless device (similar to device 112) containing spendable value. As with device 112, prize 204 can include an IC chip 2014 having a processor portion and a memory portion (not separately illustrated). An antenna 2020 can be provided for contactless communication, such as, for example, using RF electromagnetic waves. An oscillator or oscillators, and/or additional appropriate circuitry for one or more of modulation, demodulation, downconversion, and the like can be provided. In one or more embodiments, the prize 204 is substantially universally spendable in the payment card infrastructure 100. However, in other embodiments, the prize 204 may be spendable in the payment card infrastructure 100 only in connection with a limited merchant category code, a limited merchant, or a limited account type, that is, for one or more, but not all possible, uses, locations, merchant category codes, and/or types of accounts. Other possible variations include only one merchant and/or closed loop and/or serial number-back end approaches.

It will be appreciated that in the specific example of FIG. 2, the consumer product 202 comprises a bottle portion 208 and a label assembly 210 secured to the bottle portion 208. Further, the prize 204 comprises a radio-frequency contactless device containing spendable value, as just described, and forming at least a portion of the label assembly 210. Purely for purposes of illustrative convenience, both the front and back of label assembly 210 are depicted in FIG. 2. In embodiments of the invention that involve liquid-based consumer products, it may be desirable to employ special RF chips, antennas, and related circuitry that function well in the presence of liquids. In one or more embodiments, the prize is formed on a flexible substrate 2022, such that it can be bent (testing can be conducted to ensure that bending does not substantially degrade reception—it has been found that bending to the radius of an ordinary single-serving water bottle does not substantially harm reception. Further, in one or more embodiments, chip 2014 is not encapsulated, but is used in the same condition as when removed from the wafer in fabrication. Antenna 2020 may be sprayed on using, for example, conductive ink. Suitable products are available from, for example, ASK Contactless Technologies Inc., a US company located at 5101 Lindblade Dr, Culver City, Calif., 90230. ASK makes contactless thin-flexible (RF) payment card products using a printed antenna and chip inlay placed on paper-based material utilizing chips supporting contactless payment applications such as MASTERCARD PAYPASS®.

The bottle portion 208 comprises a bottle 212 and a cap 214 securable thereto. The cap 214 has an underside not visible when the cap 214 is secured to the bottle 212. The underside is visible when the cap 214 is removed from the bottle 212, and bears the indication 206 of presence of the prize, which, as previously noted, also includes an indication of a value of the prize (here, $25). In other embodiments, the indication 206 could be in another location, for example, inside of the label assembly 210.

In one or more embodiments, the prize 204 is associated with the consumer product 202 in a protected manner so as to reduce likelihood of theft of the prize. In the specific example shown, the prize is on the back of the label, which is not readily removable before purchasing the product 202.

Turning now to FIG. 3, in one or more embodiments, the label assembly 210 of FIG. 2 can be implemented as a label 302 with radio-frequency contactless device 304 formed integrally therewith. If desired, an RF-attenuating portion 306 can be cooperatively associated with the prize to prevent RF interrogation thereof in a pre-purchase configuration. In the example of FIG. 3, portion 306 is formed separately from the label assembly. Portion 306 could be, for example, a protective, conductive film, such as MYLAR® synthetic film (MYLAR® is a registered trademark of E. I. Du Pont de Nemours and Company Corporation, Delaware, USA). Other exemplary materials for the conductive film include foil (for example, aluminum or copper, optionally on a substrate which itself need not be conducting), solid metal, embedded metal elements, and the like. The film 306 prevents or reduces the likelihood of unwanted reads from potential fraudsters; winners can be instructed to remove the film and follow activation instructions on the back of it. Additional details about activation instructions will be provided below. An IC chip 2014 (not visible) and an antenna 2020 can be employed as described above.

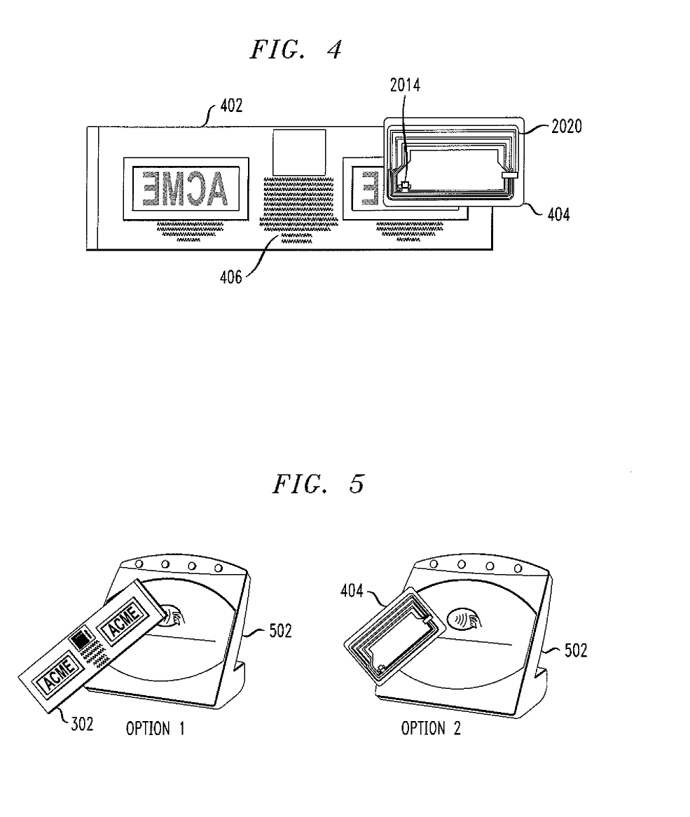

As depicted in FIG. 4, in one or more embodiments, the label assembly 210 of FIG. 2 can be implemented as a label 402 with radio-frequency contactless device 404 formed separately from the label 402, but being associated therewith, for example, glued to back of label 402 or trapped between label 402 and bottle 212. Again, an RF-attenuating portion can be cooperatively associated with the prize to prevent RF interrogation thereof in a pre-purchase configuration. In the example of FIG. 4, the RF-attenuating portion is formed integrally with the label assembly (for example, the label itself could be formed from a protective, conductive film, such as MYLAR® synthetic film. Other exemplary conductive materials for the label include foil (for example, aluminum or copper, optionally on a substrate which itself need not be conducting), solid metal, embedded metal elements, and the like. Again, the likelihood of unwanted reads from potential fraudsters is reduced or eliminated; winners can be instructed to peel off the prize to use it at the point of sale. Instructions 406 can be provided; additional details about activation instructions will be provided below. An IC chip 2014 and an antenna 2020 can be employed as described above, and prize 404 could be formed, for example, on a flexible substrate similar to flexible substrate 2022, described above.

It will be appreciated that in general terms, the prizes depicted are especially useful where the consumer product has at least one substantially non-planar surface, as the prizes can be flexible, unlike traditional cards, to substantially conform to the at least one substantially non-planar surface.

As noted above, one or more inventive assemblies can include instructions indicating how to spend the prize. In some jurisdictions, such as the United States, where security legislation such as the “PATRIOT” Act is in force; payment devices must be activated before spending; the instructions would then include activation information. The instructions could be included, for example, on the label. In the US, when an issuing bank provides an account number that can be used to redeem value, the user must typically be identified by calling a number of the issuing bank to validate that he or she received the number and consents to the appropriate terms and conditions. Under the “PATRIOT” act “know your customer” rules, it is important to verify that the user is who he or she purports to be. Thus, in some jurisdictions, there may be value on the prize that is instantly usable, but in other jurisdictions having regulations like those described, activation may be required as it would be for any payment card. In one or more embodiments, the payment number for the payment card can be a non-traditional, non-standard serial number. In this case the payment network infrastructure would be modified to accept this non-standard credit and/or debit and/or pre-paid serial number (a non-routable number) as a payment “account number” and map it to a normal (routable) payment account number in a back end system which would then process the payment transaction in a traditional manner. In any case, other instructions about how to spend the prize in the payment card infrastructure can be provided, including where and how the prize can be spent, such as at a contactless interface. The winner could be directed, for example, to a web site or an interactive voice response (IVR) system. FIG. 5 shows two possible ways to spend the value at a contactless interface 502 such as a MASTERCARD PAYPASS® interface; Option 1 corresponds to the approach of FIG. 3, where the entire label is effectively a contactless payment device, while Option 2 shows the approach with a separate device 404.

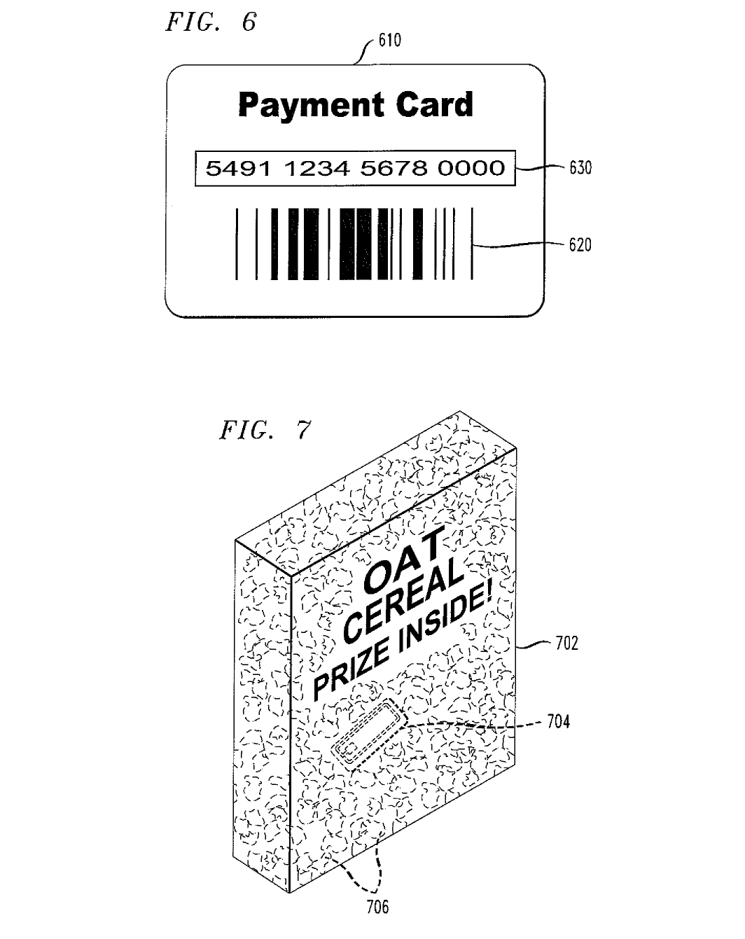

As shown in FIG. 6, in one or more embodiments of the present invention, the prize can be in the form of a payment card (or other device) 610 with a bar code 620 thereon. The bar code may be graphically printed, imprinted or placed on the card (or other device) in any manner known in the art. The bar code is encoded with the payment account information, including the BIN used to identify the issuer. A BIN (bank identification number) is a unique series of numbers that identifies the issuer of a card and which is used to route authorization request messages over existing payment card networks, such as the BANKNET network from MasterCard International Incorporated.

Preferably, in this approach, the bar code includes the “Track 2” data typically found on the magnetic stripe of conventional payment cards. The Track 2 data is in binary-coded decimal (BCD) format and contains 40 BCD characters consisting of 1) a start sentinel (1 BCD character); 2) a PAN (of up to 19 BCD characters); 3) a field separator (1 BCD character); 4) an Expiry Date (4 BCD characters), 5) a Service Code (3 BCD characters); 6) discretionary data (the length of which is dependent on the length of the PAN); 7) end sentinel (1 BCD character); and 8) longitudinal redundancy check (LRC) (1 BCD character). The length of the discretionary data field is dependent on the length of the PAN. For a standard 16-digit payment account number, there are 13 digits available for the discretionary data. Of course, while Track 2 is preferred, other data tracks on the magnetic stripe may also be used.

To use a payment card or device 610 as a prize according to the present invention, a conventional point-of-sale (POS) or other payment terminal (for example, terminal 126) may be equipped with an optical bar code reader that reads the bar code on the payment card. The information read from the card is formatted in the reader (if necessary) into regular track data and processed in the same manner as a conventional payment card over existing payment networks. Preferably, the bar code reader used is an omnidirectional bar code reader so that the payment card/device of the present invention need not be aligned in any specific orientation with regard to the reader. Since payment account digits are communicated via the bar code, this payment card/device would not suffer from the same potential for theft of information as an RF-only payment device. Use of a bar code in this manner is described in United States patent application Publication No. 2003/0225623 of John Wankmueller, the entire disclosure of which is expressly incorporated herein by reference for all purposes.

The bar code prize of FIG. 6 can be used instead of the RF prize shown in FIGS. 204 above, and the description above is equally applicable to approached using a bar coded approach instead of an RF approach. As shown at 630 in FIG. 6, in yet another approach, the prize can simply have a valid account number printed thereon. This can be in addition to or in lieu of the bar code, and again, prizes with this approach can be used in the same way as the RF prizes discussed above. In the case of the printed account number, the number can simply be keyed into a point-of-sale terminal to pay for goods or services (after any required activation).

It will be appreciated that in general, prizes in accordance with the invention do not employ magnetic stripes. In one or more embodiments, the prize can be a dual-interface payment device containing spendable value. For example, the device could have a radio-frequency (RF) contactless interface and a bar code interface (or the simple printed account number interface). Item 1302 in FIG. 1 presented a dual interface card with both contactless and contacted interfaces; contacted interfaces are not contemplated for the inventive prizes, but cards such as 1302 in FIG. 1 could be used for other purposes within the payment infrastructure.

As shown in FIG. 7, in one or more embodiments, the consumer product comprises a box 702. In one or more approaches, the prize 704 (shown in dotted lines as it is inside the box with cereal flakes 706, also shown in dotted line) is substantially loose inside the box. The prize 704, in the example shown, comprises a payment card with a substantially smaller, non-ISO ID-1 form factor. It will be appreciated that the approach of FIG. 3, where the label is itself the prize, can also employ a substantially non-ISO ID-1 form factor, and that in general, prizes used in one or more embodiments of the invention need not necessarily have to have the ISO ID-1 form factor, but they can if the label is large enough.

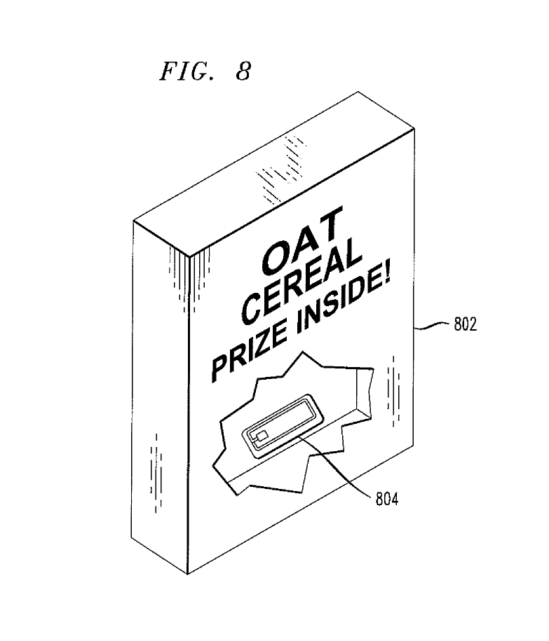

As depicted in FIG. 8. in other approaches, a prize 804 is secured inside the box 802—for example, formed integrally therewith or glued thereto as in the example, or printed on the inside of the box (the latter being especially useful for bar code or printed account number approaches).

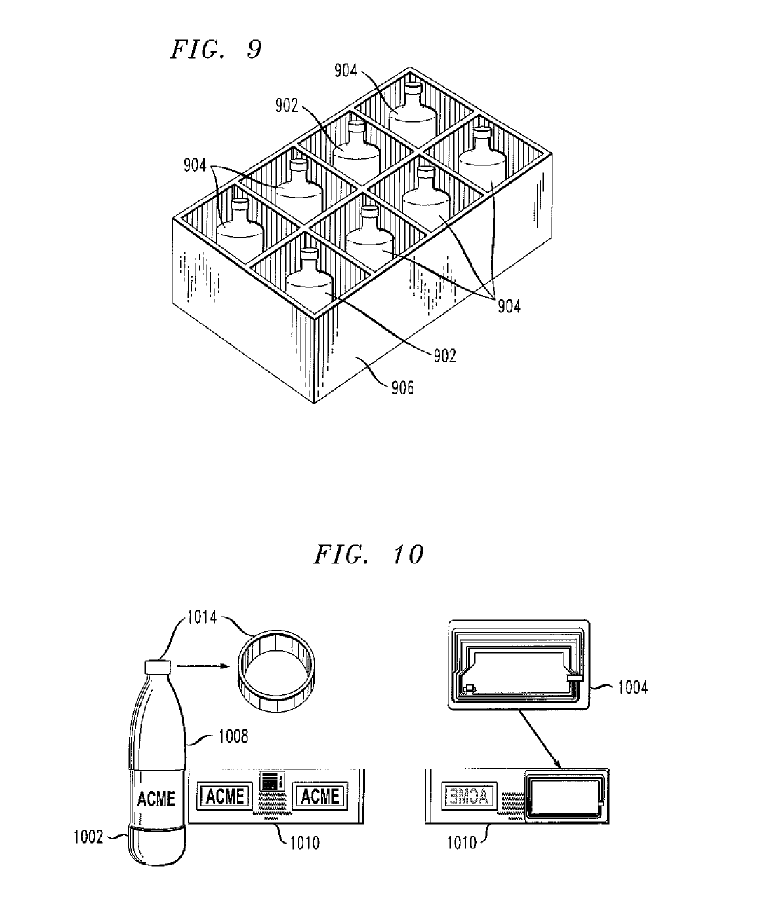

Giving attention now to FIG. 9, in another aspect, an inventive combination includes a consumer product promotional assembly 902 of any of the kinds described above, including a prize, of a first kind. Also included is a second consumer product 904. The second consumer product does not have a prize of the first kind associated therewith. The second consumer product 904 and the first consumer product 902 are cooperatively cloaked such that an observer cannot readily discern that the second consumer product 904 does not have the prize of the first kind associated therewith. In general, there may be one or more promotional assemblies 902 and one or more second consumer products 904. The terminology “prize of a first kind” is employed to include the possibility that products 904 might have a second kind of prize; however, it is envisioned that in many circumstances, the assembly or assemblies 902 will have inventive prizes and the other product or products 904 will have no prizes. In one or more approaches, a container 906 for containing the consumer product promotional assembly 902 and the second consumer product 904 may be provided. While shown as a box or tray, container 906 could also be a shelf or other point-of-sale display. In other situations, a clerk may hand the product to the consumer.

As noted, the second consumer product 904 and the first consumer product 902 are cooperatively cloaked such that an observer cannot readily discern that the second consumer product 904 does not have the prize of the first kind associated therewith. The cloaking may be against RF, visual, mechanical (the latter including tactile) discernment techniques, and the like. Where the prize comprises a radio-frequency (RF) contactless device containing spendable value, an RF-attenuating portion 306, 406, as described above, may be cooperatively associated with the prize to prevent RF interrogation thereof in a pre-purchase configuration, wherein the cooperative cloaking comprises at least substantial prevention of interrogation of the RF contactless device by the observer.

It will be appreciated that in one or more embodiments, the prize has substantial physical dimensions discernable by visual and/or mechanical techniques. With reference now to FIG. 10, in such cases, it may be advantageous to employ a dummy prize 1004 cooperatively associated with the second consumer product 904. The dummy prize 1004 can have substantial physical dimensions substantially similar to those of actual prize. In this case, the cooperative cloaking comprises at least substantial prevention of at least one of visual and mechanical discernment of presence of the prize by the observer. Items in FIG. 10 are given the same reference number as those in FIG. 2, incremented by eight hundred, it being understood that FIG. 10 depicts a “losing” product, which is one possible example of second product 904. While FIGS. 9 and 10 show bottles, the techniques therein can be employed with other products.

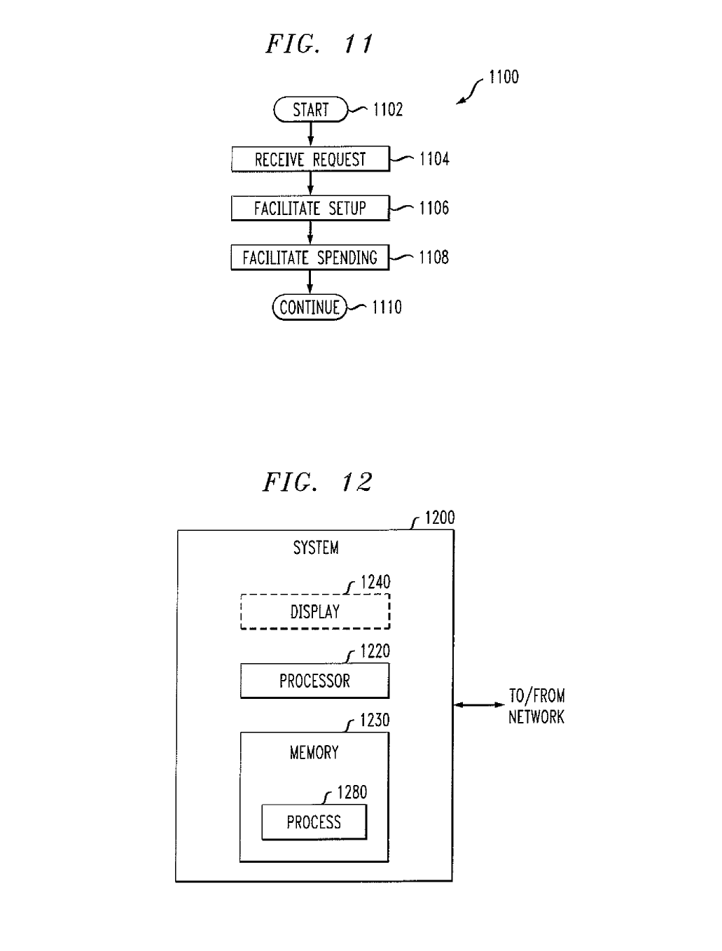

Turning now to FIG. 11, a flow chart 1100 of exemplary method steps in an inventive method of facilitating a consumer product promotion is depicted. After starting at block 1102, at block 1104, a request for setup of a routable payment account number for a prize associated with a consumer product is received (the prize being a payment device spendable in a payment card infrastructure). At block 1106, setup of said routable payment account number is facilitated. At block 1108, spending of value associated with said routable payment account number by a winner of said prize is facilitated. This can be done, for example, by the operator of a credit card processing network facilitating messaging between the parties. In one or more embodiments, activation steps as described herein can also be facilitated. Processing continues at block 1110.

It should be noted that, as used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. Further, though some steps in FIG. 11 do not refer to “facilitating” the actions, it is intended to encompass facilitating the indicated steps, as well as their actual performance, within the inventive scope.

Use of a pre-paid PAYPASS® chip in a flexible inlay as the means to deliver a pre-paid monetary award immediately to a contest winner—an instant real monetary prize. For the first time, the winner receives a valid pre-paid account object (the inlay) on the purchased item itself—here a bottle. The inlay can be a MasterCard PAYPASS® payment account embedded right in the winning object (with payment chip and attached RF antenna) usable at any PAYPASS® PAYMENT-accepting merchant globally, or the payment account can be specific or restricted for a particular use, or restricted to many locations, one specific location, merchant-type, or a specific merchant.

By way of summary, in one or more embodiments, a winner is identified, for example, when the user removes a bottle cap, and looks inside the cap to see if he or she won. If the cap indicates a winner, a usable payment account is manufactured to be attached to the back of the bottle label as a thin flexible payment-enabled inlay suitable for use in a MASTERCARD PAYPASS® contactless payment interface, or other similar interface. To use the inlay as a payment object, the winner removes the bottle label to reveal the payment inlay attached to the back of the paper bottle label, along with instructions on how to activate the pre-paid account of the inlay.

The winner, in one or more embodiments, no longer needs to wait to be sent an award—the award is on the bottle, attached to the paper label in the form of a pre-paid payment account embedded in the inlay. Preferably the inlay has a metallic or other material positioned or attached to the payment inlay that blocks or interferes with RF signals that could interact with the MASTERCARD PAYPASS® contactless chip in the inlay. This is to mask bottles with winning labels from regular bottles with non-winning labels. If the bottle cap indicates the label does not have a winning inlay, the bottle label has material that looks and feels like a valid payment inlay, which is attached to the back of the label—but it is fake—and not a functional MASTERCARD PAYPASS® contactless payment inlay object.

In some embodiments, the payment account may be usable only at one particular merchant. For instance, if the merchant is enabled to accept MASTERCARD PAYPASS® contactless payment interface payments, the payment object may use a non-standard proprietary account number of that merchant and be a “closed loop” system or the payment “account number” could just be a serial number that is used to find the payment account in a back end system of that merchant.

As an additional option, instead of an RF chip holding payment data, the paper payment card can have a printed payment account number, which, in one or more embodiments, can be in bar code format. It is to be understood that the exemplary embodiments herein, and the summary in the last three paragraphs, are not intended to be limiting, but rather illustrative.

The invention can employ hardware and/or software aspects. Software includes but is not limited to firmware, resident software, microcode, etc. Software might be employed, for example, in connection with a terminal 122, 124, 126, 134, 206, 208. Firmware might be employed, for example, in connection with payment devices such as cards 102, 112, 1302 (or corresponding prizes). FIG. 12 is a block diagram of a system 1200 that can implement part or all of one or more aspects or processes of the present invention. As shown in FIG. 12, memory 1230 configures the processor 1220 (which could correspond, e.g., to processor portions 106, 116) to implement one or more aspects of the methods, steps, and functions disclosed herein (collectively, shown as process 1280 in FIG. 12). The memory 1230 could be distributed or local and the processor 1220 could be distributed or singular. The memory 1230 could be implemented as an electrical, magnetic or optical memory, or any combination of these or other types of storage devices (including memory portions as described above with respect to cards 102, 112). It should be noted that if distributed processors are employed, each distributed processor that makes up processor 1220 generally contains its own addressable memory space. It should also be noted that some or all of computer system 1200 can be incorporated into an application-specific or general-use integrated circuit. For example, one or more method steps could be implemented in hardware in an ASIC rather than using firmware. Display 1240 is representative of a variety of possible input/output devices.

### System and Article of Manufacture Details

As is known in the art, part or all of one or more aspects of the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, EEPROMs, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. Such methods, steps, and functions can be carried out, e.g., by processing capability on elements 102, 112, 142, 122, 124, 126, 134, 140, 206, 208, or by any combination of the foregoing. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Thus, elements of one or more embodiments of the present invention, such as, for example, the aforementioned terminals 122, 124, 126, 134, 206, 208 or payment devices such as cards 102, 112, 1302 (or corresponding prizes) can make use of computer technology with appropriate instructions to implement method steps described herein. By way of further example, a terminal apparatus 122, 124, 126, 134, 206, 208 could include a communications module, an antenna coupled to the communications module, a memory, and at least one processor coupled to the memory and the communications module and operative to interrogate a contactless payment device (in lieu of the antenna and communications module, appropriate contacts and other elements could be provided to interrogate a contact payment device such as a contact card).

Accordingly, it will be appreciated that one or more embodiments of the present invention can include a computer program comprising computer program code means adapted to perform one or all of the steps of any methods or claims set forth herein when such program is run on a computer, and that such program may be embodied on a computer readable medium. Further, one or more embodiments of the present invention can include a computer comprising code adapted to cause the computer to carry out one or more steps of methods or claims set forth herein, together with one or more apparatus elements or features as depicted and described herein.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A consumer product promotional assembly comprising:
a consumer product; and
a prize associated with said consumer product, said prize being spendable in a payment card infrastructure.

2. The assembly of claim 1, further comprising:
an indication of presence of said prize, said indication being associated with at least one of said product and said prize.

3. The assembly of claim 2, wherein said indication of said presence is hidden from a purchaser in a pre-purchase configuration and visible to said purchaser in a post-purchase configuration.

4. The assembly of claim 2, wherein said indication of said presence further comprises an indication of a value of said prize.

5. The assembly of claim 1, wherein said prize comprises a radio-frequency (RF) contactless device containing spendable value.

6. The assembly of claim 5, further comprising an RF-attenuating portion cooperatively associated with said prize to prevent RF interrogation thereof in a pre-purchase configuration.

7. The assembly of claim 1, wherein said prize comprises a payment card with account information encoded thereon in bar code.

8. The assembly of claim 1, further comprising instructions indicating how to spend said prize.

9. The assembly of claim 1, wherein:
said consumer product comprises:
a bottle portion; and
a label assembly secured to said bottle portion; and
said prize comprises a radio-frequency contactless device containing spendable value and forming at least a portion of said label assembly.

10. The assembly of claim 9, wherein said label assembly comprises a label with said radio-frequency contactless device formed integrally therewith.

11. The assembly of claim 9, wherein said label assembly comprises:
a label; and
said radio-frequency contactless device, said radio-frequency contactless device being formed separately from said label, but being associated therewith.

12. The assembly of claim 11, wherein said label assembly further comprises instructions indicating how to spend said prize.

13. The assembly of claim 9, wherein said bottle portion comprises a bottle and a cap securable thereto, said cap having an underside not visible when said cap is secured to said bottle, said underside being visible when said cap is removed from said bottle, said underside of said cap bearing an indication of presence of said prize.

14. The assembly of claim 13, wherein said indication of said presence further comprises an indication of a value of said prize.

15. The assembly of claim 9, further comprising an RF-attenuating portion cooperatively associated with said prize to prevent RF interrogation thereof in a pre-purchase configuration.

16. The assembly of claim 15, wherein said RF-attenuating portion is formed integrally with said label assembly.

17. The assembly of claim 15, wherein said RF-attenuating portion is formed separately from said label assembly.

18. The assembly of claim 1, wherein:
said consumer product comprises:
a bottle portion; and
a label assembly secured to said bottle portion; and
said prize comprises a payment card with account information encoded thereon in bar code.

19. The assembly of claim 18, wherein said label assembly comprises a label with said payment card formed integrally therewith.

20. The assembly of claim 19, wherein said label assembly comprises:
a label; and
said payment card, said payment card being formed separately from said label, but being associated therewith.

21. The assembly of claim 18, wherein said label assembly further comprises instructions indicating how to spend said prize.

22. The assembly of claim 18, wherein said bottle portion comprises a bottle and a cap securable thereto, said cap having an underside not visible when said cap is secured to said bottle, said underside being visible when said cap is removed from said bottle, said underside of said cap bearing an indication of presence of said prize.

23. The assembly of claim 22, wherein said indication of said presence further comprises an indication of a value of said prize.

24. The assembly of claim 1, wherein said prize is substantially universally spendable in said payment card infrastructure.

25. The assembly of claim 1, wherein said prize is spendable in said payment card infrastructure only in connection with one of:
a limited merchant category code;
a limited merchant; and
a limited account type.

26. The assembly of claim 1, wherein said prize is associated with said consumer product in a protected manner so as to reduce likelihood of theft of said prize.

27. The assembly of claim 1, wherein said consumer product comprises a box.

28. The assembly of claim 1, wherein said prize is substantially loose inside said box.

29. The assembly of claim 1, wherein said prize is secured inside said box.

30. The assembly of claim 1, wherein said consumer product has at least one substantially non-planar surface, and wherein said prize is flexible to substantially conform to said at least one substantially non-planar surface.

31. The assembly of claim 30, wherein said prize comprises a radio-frequency (RF) contactless device containing spendable value.

32. The assembly of claim 30, wherein said prize comprises a payment card with account information encoded thereon in bar code.

33. The assembly of claim 30, wherein said prize comprises a payment card with account information presented thereon in numerical form.

34. The assembly of claim 30, wherein said prize comprises a payment card with a substantially non-ISO ID-1 form factor.

35. The assembly of claim 30, wherein said prize comprises a payment card not having a magnetic stripe thereon.

36. The assembly of claim 30, wherein said prize comprises a dual-interface payment device containing spendable value, said device having a radio-frequency (RF) contactless interface and a bar code interface.

37. In combination:
a consumer product promotional assembly comprising:
a first consumer product; and
a prize, of a first kind, associated with said first consumer product, said prize being spendable in a payment card infrastructure; and
a second consumer product, said second consumer product not having a prize of said first kind associated therewith, said second consumer product and said first consumer product being cooperatively cloaked such that an observer cannot readily discern that said second consumer product does not have said prize of said first kind associated therewith.

38. The combination of claim 37, further comprising a container for containing said consumer product promotional assembly and said second consumer product.

39. The combination of claim 37, wherein said prize comprises a radio-frequency (RF) contactless device containing spendable value, further comprising an RF-attenuating portion cooperatively associated with said prize to prevent RF interrogation thereof in a pre-purchase configuration, wherein said cooperative cloaking comprises at least substantial prevention of interrogation of said RF contactless device by said observer.

40. The combination of claim 37, wherein:
said prize has substantial physical dimensions discernable by at least one of visual and mechanical techniques;
further comprising a dummy prize cooperatively associated with said second consumer product, said dummy prize having substantial physical dimensions substantially similar to those of said prize; and
wherein said cooperative cloaking comprises at least substantial prevention of at least one of visual and mechanical discernment of presence of said prize by said observer.

41. A method of facilitating a consumer product promotion, comprising the steps of:
receiving a request for setup of a routable payment account number for a prize associated with a consumer product, said prize being a payment device spendable in a payment card infrastructure;
facilitating setup of said routable payment account number; and
facilitating spending of value associated with said routable payment account number by a winner of said prize.
